(19) United States
(12) Patent Application Publication
(10) Pub. No.: US 2011/0170190 A1
(43) Pub. Date: Jul. 14, 2011

(54) Fog Resistant Mirror

(76) Inventor: Michael V. Simunic, Wichita, KS (US)

(21) Appl. No.: 13/006,215

(22) Filed: Jan. 13, 2011

Related U.S. Application Data
(60) Provisional application No. 61/335,853, filed on Jan. 13, 2010.

(51) Int. Cl. G02B 5/08; B05D 5/06; B05D 3/02

(52) U.S. Cl. 359/507; 427/165

(57) ABSTRACT

The present development is a fog-resistant mirror. The mirror comprises a glass plate having a reflective surface on one side and an anti-fog coating on the opposing side. In a preferred embodiment, the anti-fog coating comprises two material layers: a primer coat layer applied directly to the glass plate, and a top coat applied to the primer coat layer, wherein the top coat comprises a chemical material known to resist fogging.

### CROSS-REFERENCE TO PRIOR APPLICATIONS

The present application claims priority to U.S. Provisional Patent Application 61/335,853, filed Jan. 13, 2010, which is incorporated by reference herein in its entirety.

### BACKGROUND

The present development is a coated mirror which will resist fogging under extremely humid conditions. The mirror comprises a glass plate having a reflective surface on one side and an anti-fog coating on the opposing side.

The normal mirror when used in a high humidity environment, such as in a bathroom with a shower, will tend to fog, causing the reflective value of the mirror to become unusable. Fog-resistant mirrors are commercially available, but many of these mirrors rely on heating elements (see, for example, U.S. Pat. No. 6,420,682 or U.S. Pat. No. 5,408,069), electrically conductive coatings (see, for example, U.S. Pat. No. 5,406,049, U.S. Pat. No. 5,347,106 or U.S. Pat. No. 5,083,009), or a heat transfer mechanism (see, for example, U.S. Pat. No. 6,619,805, U.S. Pat. No. 5,953,157 or U.S. Pat. No. 4,832,475) to reduce surface fogging. Because of the high humidity in the bathroom, possible corrosion of the electrical connections presents a safety risk, and may reduce the lifetime of such mirrors.

The present development is a coated mirror which will resist fogging in high humidity environments. This will allow the user to have a clearer reflection than possible with a non-coated mirror under regular use conditions.

### SUMMARY OF THE PRESENT INVENTION

The present development is a fog-resistant mirror. The mirror comprises a glass plate having a reflective surface on one side and an anti-fog coating on the opposing side. In a preferred embodiment, the anti-fog coating comprises two material layers: a primer coat layer applied directly to the glass plate, and a top coat applied to the primer coat layer, wherein the top coat comprises a chemical material known to resist fogging.

### DETAILED DESCRIPTION OF THE INVENTION

The present development is a fog-resistant mirror. The mirror is intended to be used in any location where mirrors are commonly used, but is particularly suited for use in high humidity environments. Any dimensions as provided herein, are for the purpose of demonstrating the invention, but these dimensions are not intended to limit the scope of the invention.

Specifically, the development comprises a glass plate defining a first face and a second face. The first face is coated with a reflective material. The reflective material should be applied to the glass plate such that a clear image will be reflected back to one observing the reflective material through the glass plate. Application of reflective materials to glass plates is well-known in the mirror manufacturing arts.

The second face of the mirror is covered with an anti-fog coating material. The anti-fog coating material may be any material that can be applied to a glass surface, that is essentially transparent when dry, and that retains an essentially transparent appearance when in the presence of relatively high air moisture. The anti-fog coating material should be applied to the glass plate at a thickness and in such a manner that a clear image will be reflected back to one observing the reflective material through the anti-fog coating and the glass plate. Techniques for application of anti-fog materials to glass plates are well-known in the specialty lenses manufacturing arts. In a preferred embodiment, a mirror of the present invention comprises a layer of an anti-fog coating having a thickness of up to about 12 microns, preferably from about 2 microns to about 10 microns, and more preferably from about 6 microns to about 10 microns. Optionally, after the anti-fog coating is applied, the glass plate may be baked to form a hard coating, wherein the glass plate may be baked for up to about 12 hours, preferably from about 0.1 hours to about 3 hours, and more preferably from about 0.25 hours to about 1.5 hours.

Optionally, the anti-fog coating material may comprise two or more material layers. For example, a two-layer material may comprises a primer coat layer applied directly to the second face of glass plate, and a top coat layer applied over the primer coat layer. In a preferred embodiment, a mirror of the present invention comprises a layer of an air-dry glass adhesion primer having a thickness of up to about 0.5 microns, preferably from about 0.05 microns to about 0.3 microns, and more preferably from about 0.05 microns to about 0.15 microns. In order to function as intended, the top coat layer must comprise a chemical material known to resist fogging.

The following is provided as an exemplary embodiment, and is not intended to limit the scope of the invention with respect to specific materials, dimensions, layer thicknesses, application techniques, or processing times.

A plate of glass, defining a first face and a second face, is provided. The first face of the glass plate is coated with a reflective coating to produce a mirror, using techniques that are known in the art. The second face of the glass plate is coated with a layer of an air dry glass adhesion primer, such as SP-26 available from Exxene Corporation of Corpus Christi, Tex., at a thickness of about 0.1 microns. Then a layer of an anti-fog coating, such as HCF-100-GHSX available from Exxene Corporation of Corpus Christi, Tex., is applied directly to the adhesion primer layer at a thickness of about 8 microns. After the anti-fog coating is applied, the glass plate is baked for about one hour in a clean room to form a hard coating. Once dried, the mirrored glass plate will be resistant to fogging in high humidity environments.

It is understood that one skilled in the art may make alterations to the embodiments shown and described herein without departing from the scope of the invention. For example, it is anticipated that primer coatings and anti-fog coatings other than those specified herein may be used, provided the resulting coatings are transparent when dry.

What is claimed is:

1. A fog-resistant mirror comprising:
a. a glass plate, having a first face and a second face;
b. a reflective coating, applied to the first face of said glass plate in a manner such that a clear image will be reflected back to one observing the reflective material through the glass plate; and
c. a fog-resistant coating, applied to the second face of said glass plate in a manner that a clear image will be reflected back to one observing the reflective material through the anti-fog coating and the glass plate.

2. The fog-resistant mirror of claim 1 wherein said fog-resistant coating comprises a single layer of material that is essentially transparent when dry and that retains an essentially transparent appearance when in the presence of relatively high air moisture.

3. The fog-resistant mirror of claim 1 wherein said fog-resistant coating comprises a primer layer applied directly to said second face of said glass plate, and an anti-fog coating layer applied to said primer layer.

4. The fog-resistant mirror of claim 3 wherein said primer layer is an air-dry glass adhesion primer.

5. The fog-resistant mirror of claim 3 wherein said primer layer is applied at a thickness of up to about 0.5 microns.

6. The fog-resistant mirror of claim 5 wherein said primer layer is applied at a thickness of from about 0.05 microns to about 0.3 microns.

7. The fog-resistant mirror of claim 5 wherein said primer layer is applied at a thickness of from about 0.05 microns to about 0.15 microns.

8. The fog-resistant mirror of claim 5 wherein said primer layer is applied at a thickness of about 0.1 micron.

9. The fog-resistant mirror of claim 1 wherein said anti-fog coating layer is applied at a thickness of up to about 12 microns.

10. The fog-resistant mirror of claim 1 wherein said anti-fog coating layer is applied at a thickness of from about 2 microns to about 10 microns.

11. The fog-resistant mirror of claim 1 wherein said anti-fog coating layer is applied at a thickness of from about 6 microns to about 10 microns.

12. The fog-resistant mirror of claim 3 wherein said anti-fog coating layer is applied directly to the adhesion primer layer at a thickness of about 8 microns.

13. A method for making a fog-resistant mirror, said method comprising:
a. providing a plate of glass, defining a first face and a second face;
b. coating the first face of said glass plate with a reflective coating to produce a mirror;
c. coating the second face of said glass plate with a layer of an air-dry glass adhesion primer;
d. applying a layer of an anti-fog coating directly to said adhesion primer layer; and,
e. baking the coated glass plate of step (d) until a hard coating forms.

14. The method of claim 13 wherein said primer layer is applied at a thickness of from about 0.05 microns to about 0.15 microns.

15. The method of claim 14 wherein said primer layer is applied at a thickness of about 0.1 micron.

16. The method of claim 13 wherein said anti-fog coating layer is applied at a thickness of from about 6 microns to about 10 microns.

17. The method of claim 16 wherein said anti-fog coating layer is applied directly to the adhesion primer layer at a thickness of about 8 microns.

18. The method of claim 13 wherein said coated glass plate is baked in a clean room.

19. The method of claim 13 wherein said coated glass plate is baked for up to about 12 hours.

20. The method of claim 19 wherein said coated glass plate is baked for from about 0.1 hours to about 3 hours.
